(19) United States
(12) Patent Application Publication
(10) Pub. No.: US 2011/0097074 A1
(43) Pub. Date: Apr. 28, 2011

(54) High speed motion picture film processor

(76) Inventor: Manfred G. Michelson, Calabasas, CA (US)

(21) Appl. No.: 11/134,006

(22) Filed: May 20, 2005

(51) Int. Cl. G03D 3/02

(52) U.S. Cl. 396/630

(57) ABSTRACT

A high speed motion picture film processor has a developer tank having a positive pressure relative to an ambient air pressure outside of the tank. A gas make-up system adds nitrogen inside of the developer tank while a system of seals minimizes leakage. Two seals are used along a periphery of the developer tank; one is below a sprocket level while the other is above the sprocket level. These two barriers can utilize a liquid reservoir that is filled by operation of the processor with excess liquid returning to the developer tank and they are constructed so as to allow movement. A film entrance sealing device and a film exit sealing device, each with its own housing, are also used with the developer tank; these units use a pair of rollers and a pair of flexible barriers to separate a tank gas chamber from an air chamber which is at a lower pressure and which contains a partial pressure of nitrogen fed into the entrance sealing device. The level of developer fluid is maintained at approximately the centerline of a first roller shaft but below that of a second roller shaft. The sprocket shaft has two smaller shafts mounted in metal bearings and a center tube on which the sprockets are mounted. Oxygen sensors with throttling exhaust devices outside the developer tank sound an alarm when oxygen level is too high in the developer tank. Reservoir fluid seals may also be used on secondary tanks.

### FIELD OF THE INVENTION

This invention is in the field of high speed motion picture film processors.

### BACKGROUND OF THE INVENTION

Generally, the processing, sometimes also referred to as developing, of motion picture films consists of passing an exposed film though numerous different chemical solutions.

Modern film processors, sometimes referred to as film developers, consist of a set of tanks, sprockets, and rollers. FIG. 1 shows one such tank 2. The sprockets 1 usually located on a sprocket shaft 3, located in the top of the tank or on top of the tank 2 pull the film 7 over a set of rollers 4 mounted on a roller shaft 5, usually located in the bottom of the tank 2. The sprocket shaft 3 rotates, thus rotating sprockets 1 and transporting the film. The distance between the top and bottom shaft may vary between 3 and 10 feet. The number of sprockets 1 on sprocket shaft 3 may vary from a single sprocket, for very a low speed processor, to up to twenty sprockets for a large high speed processor. On the early low speed processors, all of the sprocket shafts 3 were immersed below the solution level 8 as shown in FIG. 1.

The design speed of these processors has been increased over the years. In 1975 the fastest processors were processing film at 300 feet per minute. In 2005 some processors are running at 1000 feet per minute. The problem with processing at high speeds is that the film tension or drag increases drastically as the speed increases. At processing speeds above 1000 feet per minute the film tension becomes excessive due to solution drag. An additional problem which occurs at high speed is the whirling, or bending, of the sprocket shaft 3 which causes severe vibrations in the processor.

As a result of the tension increase at higher speeds, manufacturers began lowering the solution levels such that only a lower portion of the film was submersed in the solution as shown in FIG. 2. This works well for most solutions with the exception of the film developer solution. The film developer, the primary solution, is the solution which actually develops the film. All other solutions, which consist of such solutions as the fix, bleach, washes etc., are referred to as secondary solutions. Thus the secondary solutions only partially cover the film as shown in FIG. 2.

The problem with the primary solution is that the developer will oxidize when exposed to excessive amounts oxygen. Since air contains oxygen, oxidation of the developer solution can be eliminated by replacing the air with a gas which will not oxidize the developer.

One section of this patent deals with the design and method of maintaining a low oxygen concentration in the tank. A second section of this patent deals with eliminating the vibrations in the processor when it is running a high speeds

Filling the developer tank 2 with a non-oxidizing gas has been tried several times and found to be unsuccessful. The reason for the failure was not the principle of the approach but rather the execution. In previous attempts to do this the developer tank 2 was not properly sealed, the oxygen concentration was not monitored, the tank 2 pressure was not monitored and the film entry and exit ports were not properly sealed. Sealing the developer tank is not a trivial problem. The wet transport beams 6 may be in excess of 20 feet long and need to be raised (for maintenance purposes) by a distance of up to 10 feet above the tank 2 and again lowered to the top of the tank 2.

### SUMMARY OF THE INVENTION

The present invention is generally directed to a high speed motion picture film processor having a film feeder, a developer tank having a positive pressure relative to an ambient air pressure outside of the tank, multiple secondary tanks and a film takeup unit wherein film is fed by the film feeder into the developer tank and then into the plurality of secondary tanks before it enters the film takeup unit.

In a separate group of aspects of the present invention, the high speed motion picture film processor also has a gas make-up system for adding a non-reactive gas (such as nitrogen) inside of the developer tank and a system of seals to minimize leakage of the non-reactive gas from inside of the developer tank outside of the developer tank. The system of seals includes a first seal along a periphery of the developer tank below a sprocket level plus a tank cover and a second seal along a second periphery of the tank cover above the sprocket level, the sprocket level being determined by a centerline of a shaft that supports a plurality of sprockets used for high speed processing of film inside of the developer tank.

In another, separate group of aspects of the present invention, the first and the second seals are barriers, such as a knife-edge, with a lower end in a liquid reservoir which is filled with the developer solution by operation of the high speed motion picture film processor when the high speed motion picture film processor is in operation. Both the liquid reservoir and the barrier are constructed so as to allow movement of the barrier within the liquid reservoir without allowing the non-reactive gas to exit the developer tank when the high speed motion picture film processor is in operation. The liquid reservoirs are formed by an outer wall, a trough and an inner wall, and the height of the inner wall is less than the height of the outer wall so that when the liquid reservoir overflows any overflow will flow over the inner wall into the developer tank. A mechanism (such as an overpressure relief valve) may also be used to prevent the tank cover from being lifted up by the positive pressure inside of the developer tank.

In still another, separate group of aspects of the present invention, the secondary tanks may also have a dual sealing system similar to that described for the developer tank, although the secondary tank is maintained at a slight negative pressure relative to the ambient air pressure external the secondary tank.

In yet another, separate group of aspects of the present invention, the developer tank also has a film entrance sealing device and a film exit sealing device, each of which has a housing, a pair of rollers located inside the housing to deflect the path of the film within the housing and a pair of flexible barriers located in the housing. The pair of flexible barriers (which may be a pair of wiper blades or a barrier pair of rollers) are located in the path of the film between the pair of rollers so that the film passes between a gap (which may be approximately a few thousands of an inch or less) between the pair of flexible barriers when the film processor is in operation. The pair of flexible barriers separate a tank gas chamber located in the housing in communication with the developer tank from an air chamber located in another portion of the housing in communication with ambient air and the tank gas chamber contains the non-reactive gas contained in the developer tank at a pressure slightly higher than the pressure in the air chamber. The air chamber of the film entrance sealing device also contains a partial pressure of the non-reactive gas contained in the developer tank and non-reactive gas can be fed into the air chamber to maintain the partial pressure.

In a further, separate group of aspects of the present invention, the developer tank has a sprocket shaft with multiple sprockets and two roller shafts which each have multiple rollers located proximate a bottom of the tank but at different levels relative to one another in the tank while the developer solution is maintained at a fluid level which is approximately located at a centerline of the first roller shaft so that the rollers of the second roller shaft are above the centerline and thus above the developer solution.

In still a further, separate group of aspects of the present invention, the sprocket shaft in the developer tank has a two small shafts mounted on two sets of bearings (which may be metal bearings) inside two beams with two flexible seals for preventing gas from leaving the developer tank on two sides of the developer tank opposite each other and a tube (which may be solid, but is preferably hollow) with a larger diameter than the small shafts is affixed at each of its ends to one of the small shafts, while sprockets are mounted on the tube. Rotational and lateral movement of the sprockets on and relative to the tube can be prevented. One way to prevent rotational movement of the sprockets is to use pins inserted through the tube and held in place by opposing indents formed in the sprockets. The inside of the two beams can be slightly pressurized relative to the positive pressure of the developer tank.

In yet a further, separate group of aspects of the present invention, an oxygen sensor is located outside of the developer tank for sounding an alarm whenever oxygen concentration exceeds a desired set point. A gas line feeds the non-reactive gas inside of the developer tank to a filter and then to the oxygen sensor due to the positive pressure of the non-reactive gas within the developer tank, and the gas may be exhausted through a throttling device. A secondary oxygen sensor, with its own exhaust throttling device, may also be located outside of the developer tank and the flow of gas may periodically be switched between the two oxygen sensor devices.

Accordingly, it is a primary object of the present invention to provide an improved high speed motion picture film processor.

This and further objects and advantages will be apparent to those skilled in the art in connection with the drawings and the detailed description of the preferred embodiment set forth below.

### BRIEF DESCRIPTION OF THE DRAWINGS

FIG. 1 is a schematic representation of a single rack of a developing solution tank of a prior art high speed motion picture film processor.

FIG. 2 is a schematic representation of a single rack of a secondary tank of a prior art high speed motion picture film processor with a lower fluid level than of FIG. 1.

FIG. 3 is a schematic representation of a single rack of a high speed motion picture film processor in accordance with the present invention.

FIG. 3A is a top planar view of a partial cutaway along line 3A-3A of FIG. 3.

FIG. 4 illustrates a sprocket shaft design for use in a high speed motion picture film processor in accordance with the present invention.

FIG. 4A is a cross section view of FIG. 4.

FIG. 4B is an end view cross section of FIG. 4.

FIGS. 5 and 7 illustrate sealing devices for a developer tank used in a high speed motion picture film processor in accordance with the present invention.

FIG. 6 is a diagrammatic view of an oxygen sensor mechanism in accordance with the present invention.

FIG. 8 illustrates an especially preferred fluid level in a developer tank in accordance with the present invention.

FIG. 9 illustrates a pressure relief mechanism for a tank in accordance with the present invention.

FIG. 9A is a cross section view of FIG. 9.

FIG. 10 is a diagrammatic view of a high speed motion picture film processor in accordance with the present invention.

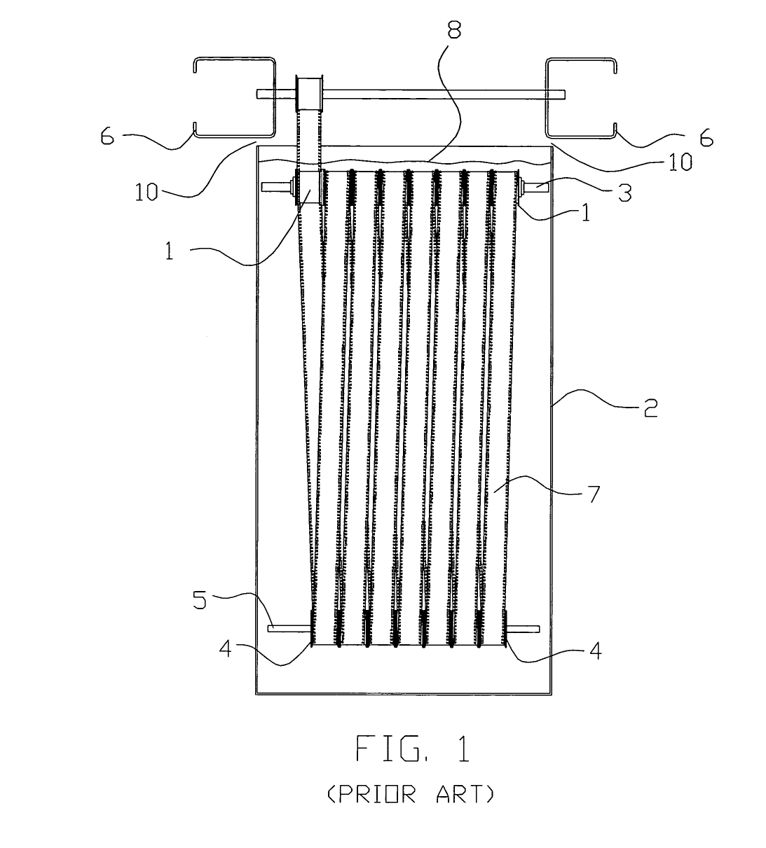

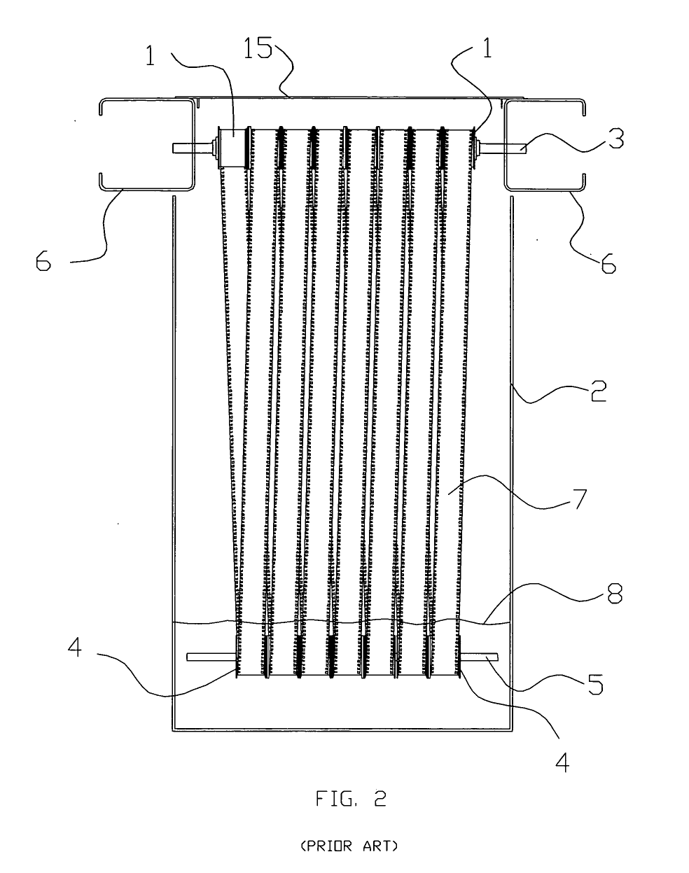

### DETAILED DESCRIPTION OF THE INVENTION

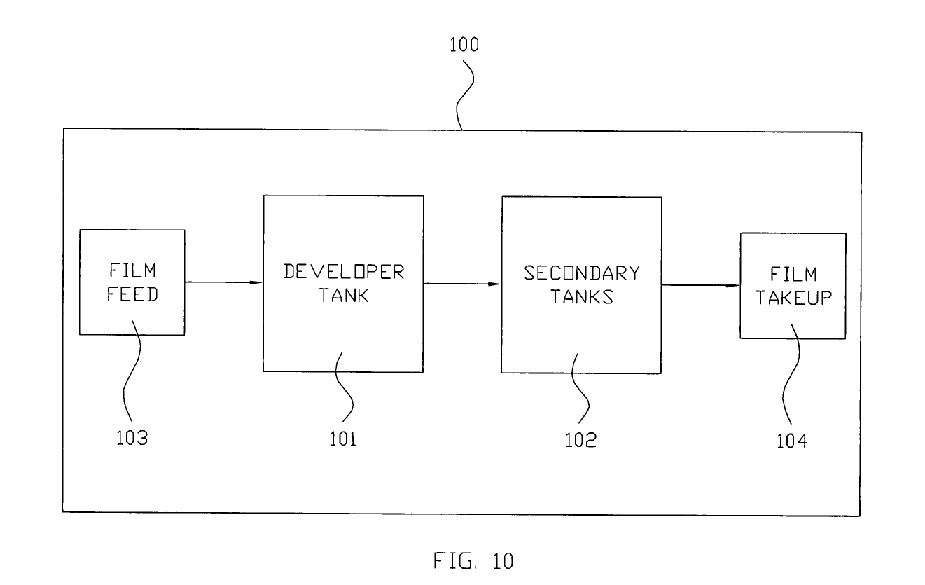

In accordance with the present invention, a high speed motion picture film developer is disclosed that can be represented in a simplified schematic diagram as shown in FIG. 10. The high speed motion picture film developer, shown generally as 100, has a film feed 103 to developer tank 101 and then secondary tanks 102 and a film takeup 104.

The present invention will now be described in connection with several especially preferred embodiments that illustrate various aspects of the inventive concepts described herein. In the Figures and the following more detailed description, numerals indicate various features of the invention, with like numerals referring to like features throughout both the drawings and the description. Although the Figures are described in greater detail below, the following is a glossary of the elements identified in the Figures:
1 Sprocket
2 Tank
3 Sprocket Shaft
4 Roller
5 Roller Shaft
6 Beam
7 Film
8 Solution Level
9 Tank Cover
10 Gap
11 Tank Seal Channel
12 Beam Seal Channel
13 Bearing
14 Solution
16 Knife Edge
17 Liquid
18 Inside Lip
19 Seal Roller
20 Wiper Blades
21 Wiper Blade Housing
22 Filter
23 Primary Oxygen Sensor
24 Two-way Valve
25 Secondary Sensor
26 Gas Exhaust
27 Throttling Device
28 Pressure Gauge
29 Differential Pressure Gauge
30 Air Chamber
31 Tank Gas Chamber
32 Tube
33 Retainer Ring
34 Small Shaft
35 Pin
36 Ambient Air
37 Keyway
38 Direction of Film Travel
39 Upper Roller Shaft
40 Lower Roller Shaft
41 Flexible Sheet
42 Weight
43 Clamp
44 Make-up nitrogen system
46 Upper Knife Edge
48 Outside Lip of Beam Seal Channel 12
51 Lower Liquid Reservoir
52 Upper Liquid Reservoir
100 High Speed Film Processor
101 Developer Tank
102 Secondary Tanks
103 Film Feeder
104 Film Takeup

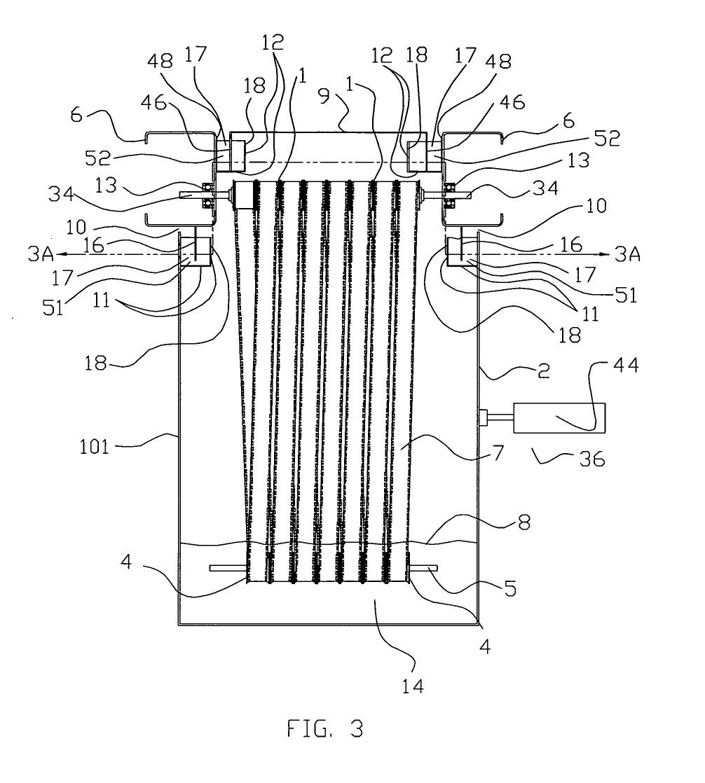

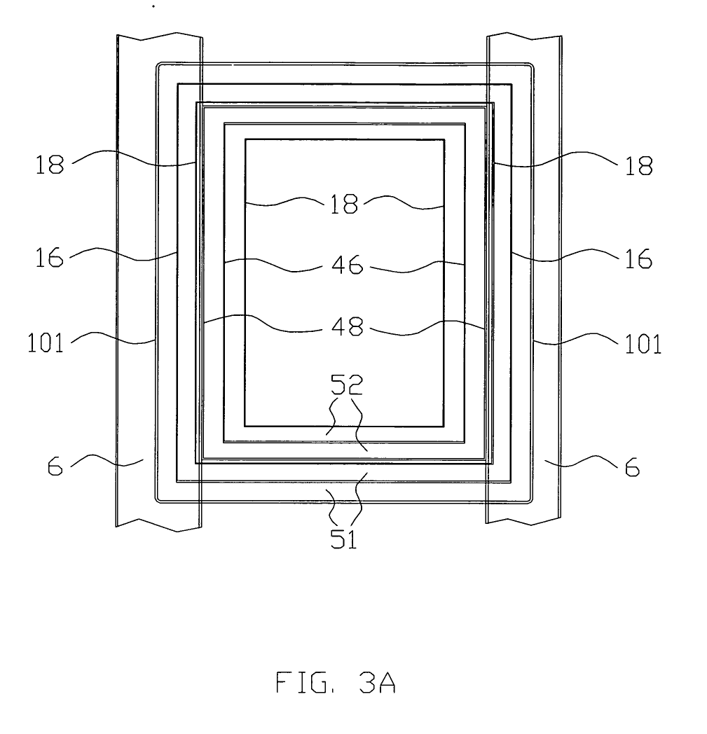

In accordance with an especially preferred embodiment of the present invention shown in FIG. 3, to ensure that developer tank 101 containing developer solution 14 does not have any, or very little, oxygen, the entire tank is pressurized with a tank gas which does not oxidize the developer solution. One such gas is nitrogen. There are many other gasses which will prevent oxidation; from here on nitrogen is used as an especially preferred example in view of its ease of use and cost advantage over other gasses.

To ensure that no oxygen enters developer tank 101, the nitrogen is under positive pressure relative to the air outside the tank. To maintain the positive pressure and compensate for gas leakage, a small amount of nitrogen is continuously pumped into the tank by a make-up nitrogen system 44. To maintain this pressure, the system has to be sealed. In an especially preferred embodiment of the present invention, gaps 10 between beams 6 and developer tank 101 are sealed by a u-shaped tank seal channel 11 (having an outer wall, a trough and an inner wall) that is welded to the entire periphery of the tank as shown in FIG. 3. A barrier, which may be a knife edge 16, is attached to beams 6 as shown is FIG. 3. This knife edge extends into the tank seal channel 11 around the entire periphery of the tank. When tank seal channel 11 is filled with a liquid 17 to form lower liquid reservoir 51, gaps 10 between beams 6 and developer tank 101 are sealed. (A knife edge barrier is especially preferred because there is movement in high speed film processor 100 in use so a more solid seal will not work as effectively, especially over time.)

Similarly, a tank cover 9 with a similar barrier or knife edge 46 is placed into beam seal channel 12. Beam seal channel 12 is connected to beams 6 and runs around the entire periphery of tank cover 9. Beam seal channel 12 can be constructed with a u-shaped channel that is itself affixed to beams 6 or an outside lip 48 of the u-shaped channel can be formed by using the beam itself as a wall. Filling beam seal channel 12 with a liquid forms upper liquid reservoir 52 that provides a seal for the top of developer tank 101 in the same fashion as lower liquid reservoir 51 provides a seal for the developer tank 101 below sprockets 1.

Small shaft 34 is mounted on bearings 13. Bearings 13 have a flexible seal on both sides of bearing 13 which seals the bearing and thus seals the inside of developer tank 101 from ambient air 36.

Since the entire developer tank 101 is under positive pressure, tank cover 9 must be of sufficient weight or must be mechanically latched to beams 6 so that tank cover 9 is not lifted up by the pressure in developer tank 101.

The seals as described above serve an additional purpose. As film 7 moves through the developer solution, a substantial amount of solution is carried to the top of developer tank 101. The seals and covers as described above form a substantially complete seal, if not a complete seal, which prevents the solution from spilling outside developer tank 101.

As film 7 is transported through developer tank 101, there is a tremendous amount of splashing of solution 14 throughout the tank. Inside lip 18 (i.e., the vertical section of tank seal channels 11) must be lower than the top edge of developer tank 101 to prevent liquid 14 from leaving developer tank 101 by spilling over the outside side of the tank. For the same reason, inside lip 18 of beam seal channel 12 (i.e., the vertical section of beam seal channel 12) must be lower than the top of beams 6 to prevent spilling outside of the tank since the tremendous amount of solution splashing within the tank enclosure will automatically fill seal channels 11 and 12 with developer fluid 14.

An important aspect of this especially preferred embodiment of design of tank seal channel 11 and beam seal channel 12 is that the both channels remain full of solution, due to the solution 14 splashing, at all times and thus sealing the tank 2.

The seals described above may also be employed on secondary tanks 102 having secondary solutions to prevent such solutions from spilling outside secondary tanks 102 and to also prevent undesired fumes from escaping from such tanks. Sealing the undesired fumes and preventing them from escaping into the immediate environment is extremely important. There are very pungent and environmentally damaging fumes in the tanks which do present health hazards. Secondary solution tanks 102 are usually provided with a slight negative pressure relative to the ambient pressure to ensure that any leakage into the secondary tanks will be exhausted to the outside of the processor building.

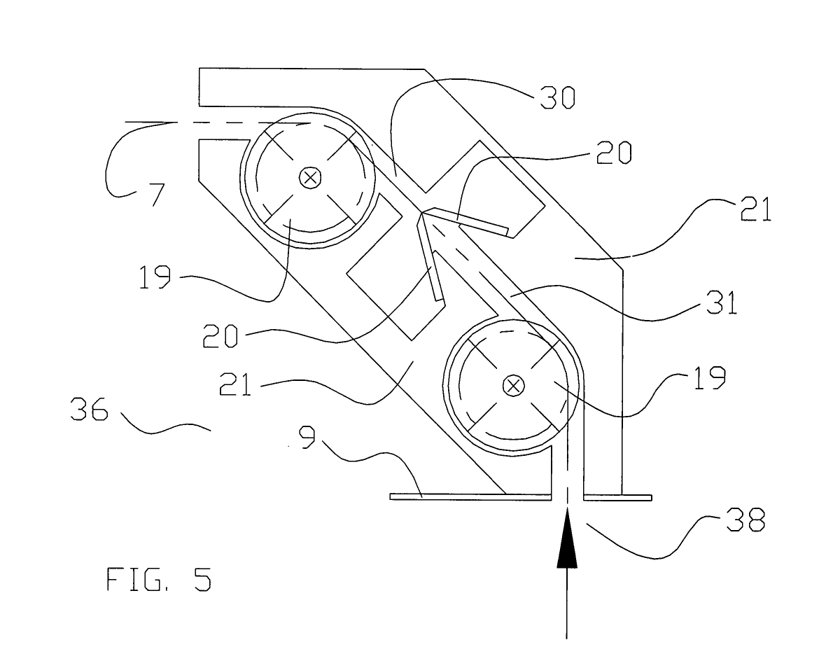

In addition to all of the seals mentioned above, developer tank 101 needs a sealing device which seals film 7 as it enters and exits developer tank 101. FIG. 5 shows such a sealing device which seals film 7 as it exits developer tank 101. The direction of film travel 38 is shown in FIG. 5. Film 7 passes over two seal rollers 19. Each of these rollers 19 deflect the film path by a slight amount as the film bends around the rollers such that film 7 is not free to flutter between the rollers. Between rollers 19 there are two flexible barriers. In an especially preferred embodiment, the flexible barriers are wiper blades 20, although the barriers might also be another set of rollers or some other barrier device that will not damage the film but still serve to create two chambers. Wiper blades 20 may be adjusted such that they just touch film 7 or such that there is a small gap between film 7 and the wiper blade 20 (which can be made of a suitable flexible material such as rubber or plastic). Wiper blades 20 and rollers 19 are enclosed by a housing 21. The width of wiper blades 20 is only a few thousands of and inch wider than the width of film 7. The width of the cavity in the wiper blade housing is slightly wider (which can be a few thousands of an inch) than the wiper blade. This ensures that only a small amount of gas escapes into the environment. Housing 21 is mounted either on top of the tank cover 9 or through a wall separating developer tank 101 from the adjoining tanks. The lower portion of housing 21, which is connected to the tank cover, is automatically filled with nitrogen from developer tank 101, and this is called tank gas chamber 31. The wiper blades separate tank gas chamber 31 from air chamber 30. A small amount of nitrogen will escape to ambient air 36 as the film exits the tank through tank gas chamber 31 and air chamber 30. This nitrogen has to be replenished by an outside source.

As liquids are added or removed from developer tank 101 the tank pressure may change. If the tank pressure becomes negative the tank will suck in air and therefore oxygen. Consequently, the nitrogen pressure must be controlled with a pressure regulator and must at all times be positive relative to the pressure external to developer tank 101. This positive pressure assures that there is a positive pressure gradient moving from tank gas chamber 31 to air chamber 30. Also, when high speed film processor 100 is turned off, the gas temperature of gas inside of developer tank 101 will cool (the solution might be at 100° F. when running) and additional nitrogen must then be added to the inside of developer tank 101 to maintain its positive pressure (according to Boyle's Law).

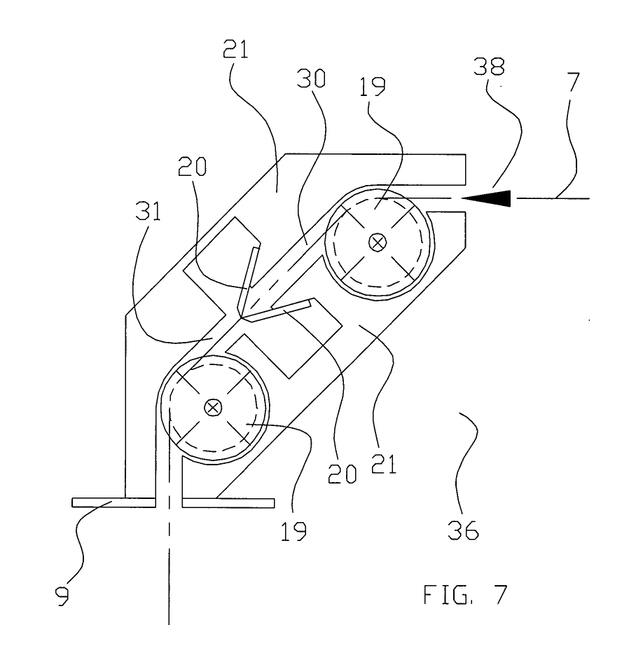

The film seal device for sealing the film as it enters developer tank 102 is shown in FIG. 7. This is quite similar to the device shown in FIG. 5 with the following difference.

As a result of nitrogen passing from tank gas chamber 31 to air chamber 30 there is a certain tank gas concentration in air chamber 30. This is important for the film entering developer tank 101. A partial tank gas atmosphere in air chamber 30 ensures that the perforations in the film are at least partially purged of oxygen. This causes less oxygen to be drawn into developer tank 101. Also, air chamber 30 can be designed to be very large and the partial pressure of tank gas inside of air chamber 30 can be controlled through addition of tank gas into air chamber 30 to minimize oxygen that might be carried into tank gas chamber 31 by film perforations.

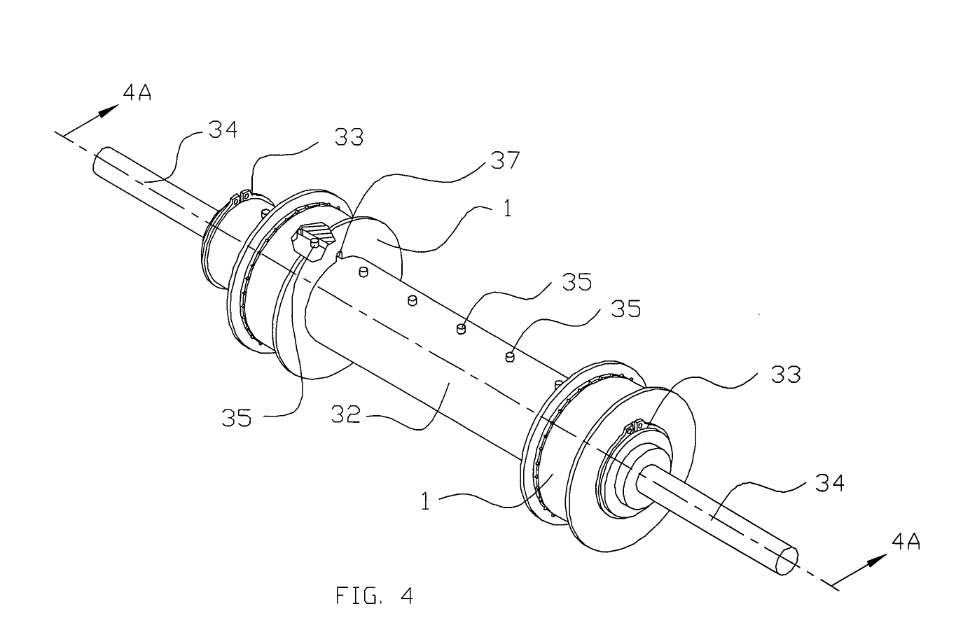

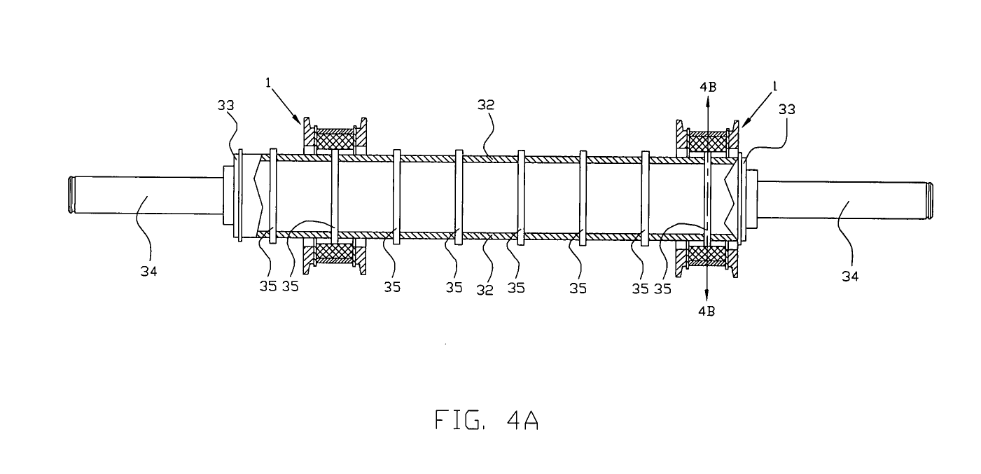

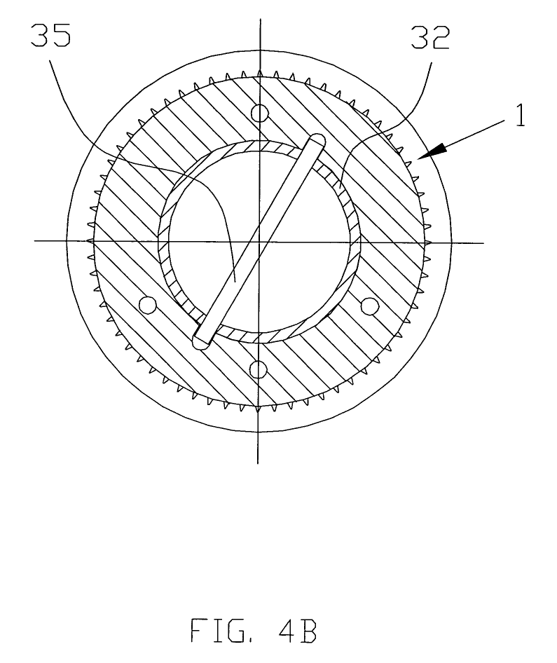

Running processors at high speeds requires that sprocket shaft 3 is quite straight. FIG. 4 shows an especially preferred sprocket shaft design in accordance with the present invention which is capable of carrying a high load while still remaining quite straight. The shaft consists of a tube 32 which is at least 2 inches in diameter and is much more rigid than a traditional sprocket shaft 3. It is especially preferred that tube 32 be at least partially hollow due to weight and cost concerns, although a solid shaft would still be an improvement over prior devices because of its increased stiffness. Sprockets 1 (only two sprockets are shown in FIG. 4) are held on the shaft by a retainer ring 33, or a circular clamp, at each end of the shaft. Screwed or welded into each end of the shaft is a solid smaller shaft 34 with a diameter small enough to fit into a metal bearing 13. The individual sprockets 1 are kept from rotating on the shaft by pins 35 as shown in FIG. 4. Pins 35 are longer than the diameter of the shaft and protrude from each side of the shaft. Sprockets 1 have two keyways 37 on the inside bore which are spaced 180 degrees apart. It is these keyways 37 which keep pins 35 from falling out of tube 32.

In an especially preferred embodiment of the present invention small shafts 34 are not submersed. Submersed shafts can ordinarily only be run on plastic bearings because of corrosion problems encountered in the liquids. When small shafts 34 are mounted on the surface, they can be mounted on metal bearings which have a far longer life than plastic bearings. In order to prevent the developer solutions from migrating into the bearings, the inside of beams 6 are slightly pressurized relative to the inside of developer tank 101. This pressure causes any fluid which might migrate into the bearing to be forced out of the bearing and back into developer tank 101.

In order to ensure that developer tank 101 is always pressurized the tank must be equipped with a pressure gauge and an alarm which will sound if the pressure in the tank falls below a minimum set point.

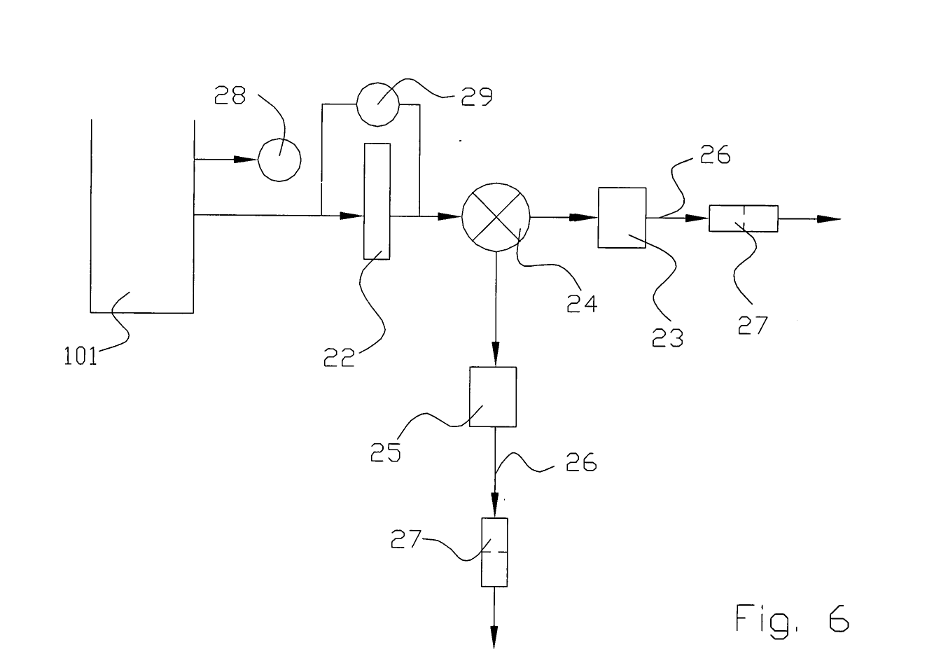

Additionally, it is especially preferred that developer tank 101 is equipped with a primary oxygen sensor 23 (FIG. 6) which will indicate the oxygen level and sound an alarm whenever the oxygen level exceeds a desired set point. Because the sensing element of primary oxygen sensor 23 may become damaged in time from pollutants from the developer solution, a filter 22, such as an activated charcoal filter, should be placed in line between the tank and the oxygen sensor as shown in FIG. 6. To ensure that oxygen sensor 23 is operational, it is especially preferred that a secondary oxygen sensor 25 be installed in the system and gas flow from the tank may be switched periodically by a two-way valve 24 to determine if primary oxygen sensor 23 is operating properly. The pressure for the gas flow through the oxygen sensor is provided automatically by the pressure inside developer tank 101. The gas leaving sensors 23 and 25 is exhausted to the ambient air through gas exhaust 26. To ensure that the concentration of gas inside the oxygen sensors 23, 24 reflects the gas concentration inside developer tank 101, a throttling device 27 is placed at the exhaust end of gas exhaust 26. Throttling device 27 may consist of a small orifice or a porous material. An additional purpose of throttling device 27 is to limit the amount of gas escaping the system. To ensure that the tank 101 pressure is positive, a pressure gauge 28 is connected to the tank 101. See FIG. 6. To ensure that filter 22 is not clogged, a pressure gauge 29 is connected between the input and the output of filter 22. Pressure gauge 28 must have an alarm which rings when the pressure in the tank falls below a certain set point and an alarm set point which rings when the pressure exceeds a predetermined point.

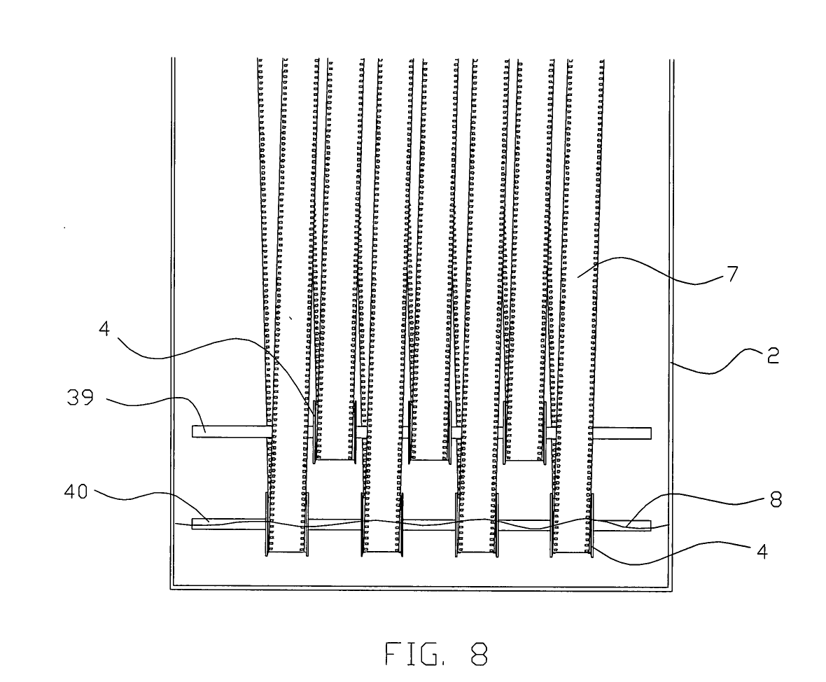

FIG. 3 shows a single roller shaft 5 at the bottom of tank 2. In practice and for practical reasons there are often two roller shafts, upper roller shaft 39 and lower roller shaft 40, as shown in FIG. 8. FIG. 3 shows the solution level 8 covering all rollers 4. As shown in FIG. 8, when the rollers 4 are divided between upper roller shaft 39 and lower roller shaft 40, it is possible to have the solution level 8 cover only the lower rollers 4. Covering only half the rollers with a solution cuts the film drag in half. This in turn reduces the horsepower required to run the entire processor. Additionally, for purposes of reducing the film drag, it is especially preferred that solution level 8 be lowered to the centerline of lower shaft 40.

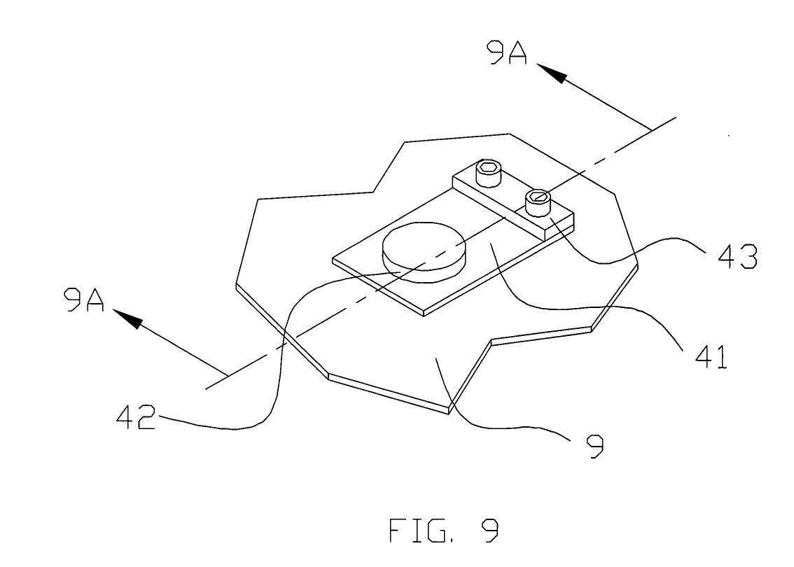

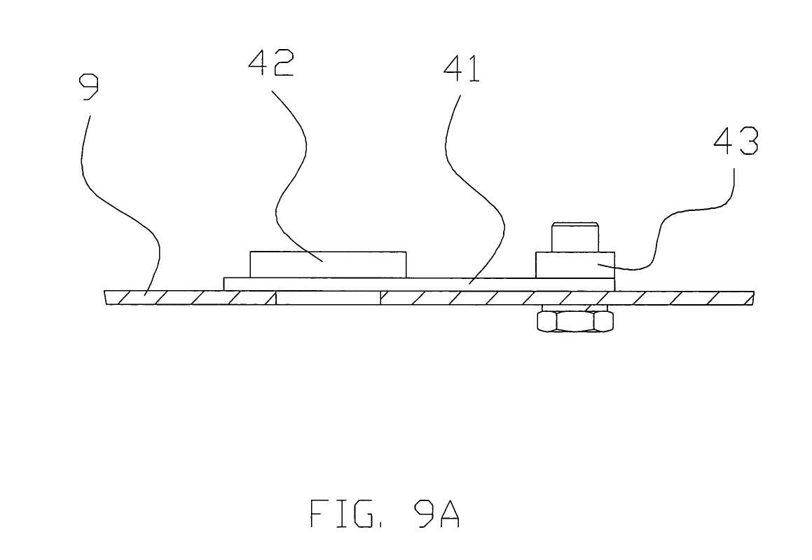

Upon starting the processor 100, referring to FIG. 8, the gas above the solution level 8 is typically at a lower temperature than the solution at the bottom of the tank. Once the solution is mixed with the gas covering the solution, the gas in developer tank 101 rapidly increases in temperature. This increase in temperature will cause an increase in gas pressure. To prevent this pressure from forcing the liquid 17 out of seal 12 developer tank 101 has to be equipped with a pressure relief valve. One design of such a valve is shown in FIG. 9. This particular pressure relief valve may be placed on top of a small hole of the tank cover 9. This particular relief valve consists of a flexible sheet 41. This flexible sheet may consist of either a rubber-like or plastic material. Attached to the top of the flexible sheet 41 is a weight 42. This weight 42 must be of sufficient weight to maintain the gas pressure within developer tank 101 but light enough to prevent liquid 17 from being forced out of seal 12. Flexible sheet 41 may be attached to the tank cover by a clamp 43 as shown in FIG. 9. It is especially preferred that an overpressure relief valve is used in both developer tank 101 and in secondary tanks 102.

While the invention has been described herein with reference to several especially preferred embodiments, these embodiments have been presented by way of example only, and not to limit the scope of the invention. Additional embodiments thereof will be obvious to those skilled in the art having the benefit of this detailed description, especially to meet specific requirements or conditions. For example, while the preferred embodiments have been disclosed as using a liquid reservoir system for seals along the periphery of the developer or secondary tanks, a different suitable seal system could also be put into place, such as an inflatable seal that could replace the liquid reservoir system and still accommodate movement which is common when the high speed motion picture film processor is in operation. Further modifications are also possible in alternative embodiments without departing from the inventive concept.

Accordingly, it will be apparent to those skilled in the art that still further changes and modifications in the actual concepts described herein can readily be made without departing from the spirit and scope of the disclosed inventions as defined by the following claims.

What is claimed is:

1. A high speed motion picture film processor, comprising:
a film feeder;
a developer tank having a positive pressure relative to an ambient air pressure outside of the tank;
a plurality of secondary tanks; and
a film takeup unit;
wherein film is fed by the film feeder into the developer tank and then into the plurality of secondary tanks before it enters the film takeup unit.

2. The high speed motion picture film processor of claim 1, further comprising:
a gas make-up system for adding a non-reactive gas inside of the developer tank; and
a system of seals to minimize leakage of the non-reactive gas from inside of the developer tank outside of the developer tank.

3. The high speed motion picture film processor of claim 2, wherein the non-reactive gas is nitrogen.

4. The high speed motion picture film processor of claim 2, wherein the system of seals includes a first seal along a periphery of the developer tank below a sprocket level; a tank cover and a second seal along a second periphery of the tank cover above the sprocket level;
wherein the sprocket level is determined by a centerline of a shaft that supports a plurality of sprockets used for high speed processing of film inside of the developer tank.

5. The high speed motion picture film processor of claim 4, further comprising means for preventing the tank cover from being lifted up by the positive pressure inside of the developer tank.

6. The high speed motion picture film processor of claim 4, wherein the first and the second seals are comprised of a barrier with a lower end in a liquid reservoir which is filled with the developer solution when the high speed motion picture film processor is in operation.

7. The high speed motion picture film processor of claim 6, wherein the barrier is a knife-edge.

8. The high speed motion picture film processor of claim 6, wherein operation of the high speed motion picture film processor fills the liquid reservoir of both the first and the second seals.

9. The high speed motion picture film processor of claim 6, wherein the liquid reservoir and the barrier are constructed so as to allow movement of the barrier within the liquid reservoir without allowing the non-reactive gas to exit the developer tank when the high speed motion picture film processor is in operation.

10. The high speed motion picture film processor of claim 9, wherein the liquid reservoir is formed by an outer wall, a trough and an inner wall, and the height of the inner wall is less than the height of the outer wall so that when the liquid reservoir overflows any overflow will flow over the inner wall into the developer tank.

11. The high speed motion picture film processor of claim 1, wherein the plurality of secondary tanks system includes at least one secondary tank having a first secondary tank seal along a periphery of the secondary tank; a secondary tank cover and a second secondary tank seal along a second periphery of the tank cover, wherein the first and the second secondary tank seals are comprised of a barrier with a lower end in a liquid reservoir which is filled with a secondary tank solution when the high speed motion picture film processor is in operation.

12. The high speed motion picture film processor of claim 11, wherein operation of the high speed motion picture film processor fills the liquid reservoir of both the first and the second secondary tank seals.

13. The high speed motion picture film processor of claim 12, wherein the liquid reservoir and the barrier are constructed so as to allow movement of the barrier within the liquid reservoir without allowing gas to exit the secondary tank when the high speed motion picture film processor is in operation.

14. The high speed motion picture film processor of claim 13, wherein the liquid reservoir is formed by an outer wall, a trough and an inner wall, and the height of the inner wall is less than the height of the outer wall so that when the liquid reservoir overflows any overflow will flow over the inner wall into the secondary tank.

15. The high speed motion picture film processor of claim 11, wherein the secondary tank is maintained at a slight negative pressure relative to the ambient air pressure external the secondary tank.

16. The high speed motion picture film processor of claim 2, wherein the system of seals further comprises a film entrance sealing device and a film exit sealing device.

17. The high speed motion picture film processor of claim 16, wherein the film exit device is comprised of:
a housing;
a pair of rollers located inside the housing to deflect the path of the film within the housing;
a pair of flexible barriers located in the housing in the path of the film between the pair of rollers such that the film passes between a gap between the pair of flexible barriers when the film processor is in operation and the pair of flexible barriers separate a tank gas chamber located in a first portion of the housing in communication with the developer tank from an air chamber located in a second portion of the housing in communication with ambient air;
wherein the tank gas chamber contains the non-reactive gas contained in the developer tank at a pressure slightly higher than the pressure in the air chamber.

18. The high speed motion picture film processor of claim 17, wherein the film entrance device is comprised of:
a second housing;
a second pair of rollers located inside the second housing to deflect the path of the film within the second housing;
a second pair of flexible barriers located in the second housing in the path of the film between the second pair of rollers such that the film passes between a second gap between the second pair of flexible barriers when the film processor is in operation and the second pair of flexible barriers separate a second tank gas chamber located in a first portion of the second housing in communication with the developer tank from an air chamber located in a second portion of the second housing in communication with ambient air;
wherein the second tank gas chamber contains the non-reactive gas contained in the developer tank at a pressure slightly higher than the pressure in the air chamber; and
wherein the second air chamber contains a partial pressure of the non-reactive gas contained in the developer tank.

19. The high speed motion picture film processor of claim 18, wherein the first and second gaps are approximately a few thousands of an inch or less.

20. The high speed motion picture film processor of claim 19, wherein the first and second pair of flexible barrier are selected from the group consisting of a pair of wiper blades and a barrier pair of rollers.

21. The high speed motion picture film processor of claim 18, wherein the non-reactive gas is fed into the air chamber to maintain the partial pressure.

22. The high speed motion picture film processor of claim 1, wherein the developer tank is further comprised of a sprocket shaft with a plurality of sprockets and a first and a second roller shaft, each of the first and second roller shafts having a plurality of rollers, the first and the second roller shaft being located proximate a bottom of the tank but at different levels relative to one another in the tank.

23. The high speed motion picture film processor of claim 22, wherein a developer solution is maintained in the developer tank at a fluid level which is approximately located at a centerline of the first roller shaft;
wherein the second roller shaft is positioned so that its plurality of rollers are above the centerline; and
wherein film fed into the tank travels between over each of the plurality of sprockets and the plurality of rollers of both the first and the second roller shafts before it leaves the tank.

24. The high speed motion picture film processor of claim 21, wherein the sprocket shaft is further comprised of:
a first small shaft mounted on a first set of bearings inside a first beam with a first flexible seal for preventing gas from leaving the developer tank on a first side of the developer tank;
a second small shaft mounted on a second set of bearings inside a second beam with a second flexible seal for preventing gas from leaving the developer tank on a second side of the developer tank opposite the first side of the developer tank; and
a tube affixed at one end to the first small shaft and at its other end to the second small shaft;
wherein the tube has a larger diameter than the first and the second small shafts; and
wherein the plurality of sprockets are mounted on the tube.

25. The high speed motion picture film processor of claim 24, further comprising means for preventing each of the plurality of sprockets from rotating.

26. The high speed motion picture film processor of claim 24, wherein each of the plurality of sprockets is kept from rotating by a pin that is inserted through the tube and is held in place by opposing indents formed in said sprocket.

27. The high speed motion picture film processor of claim 24, further comprising means for preventing lateral movement of the plurality of sprockets relative to the tube.

28. The high speed motion picture film processor of claim 24, wherein the first and the second sets of bearings are metal bearings.

29. The high speed motion picture film processor of claim 24, wherein the inside of the first and the second beams are slightly pressurized relative to the positive pressure of the developer tank.

30. The high speed motion picture film processor of claim 2, further comprising:
a primary oxygen sensor located outside of the developer tank for sounding an alarm whenever oxygen concentration exceeds a desired set point;
a filter; and
a gas line for feeding the non-reactive gas inside of the developer tank to the filter and then to the primary oxygen sensor.

31. The high speed motion picture film processor of claim 30, wherein the non-reactive gas is fed to the primary oxygen sensor due to the positive pressure of the non-reactive gas within the developer tank.

32. The high speed motion picture film processor of claim 31, further comprising:
a primary oxygen sensor exhaust for exhausting the non-reactive gas from the primary oxygen sensor; and
a primary oxygen sensor exhaust throttling device placed at the primary oxygen sensor exhaust.

33. The high speed motion picture film processor of claim 30, further comprising:
a secondary oxygen sensor located outside of the developer tank for sounding an alarm whenever oxygen concentration exceeds the desired set point; and
a switching device for periodically switching flow of gas from the filter to the secondary oxygen sensor instead of the primary oxygen sensor and then to switch the flow of gas back again to the primary oxygen sensor.

34. The high speed motion picture film processor of claim 33, further comprising:
a secondary oxygen sensor exhaust for exhausting the non-reactive gas from the secondary oxygen sensor; and
a secondary oxygen sensor exhaust throttling device placed at the secondary oxygen sensor exhaust.

35. The high speed motion picture film processor of claim 2, further comprising an overpressure relief valve.

36. A method for processing a reel film in a high speed motion picture film processor in which the reel film is processed in a developer tank at a high speed through use of a sprocket shaft with a plurality of sprockets and a first and a second roller shaft, each of the first and second roller shafts having a plurality of rollers, the first and the second roller shafts being located proximate a bottom of the developer tank but at different levels relative to one another in said tank, comprising the step of:
maintaining a fluid level of a developer solution in the developer tank at a height such that the fluid level is approximately located at a centerline of the first roller shaft and the plurality of rollers on the second roller shaft are above the centerline.

37. A high speed motion picture film processor, comprising:
a film feeder;
a developer tank having a sprocket shaft with a plurality of sprockets and a first and a second roller shaft, each of the first and second roller shafts having a plurality of rollers, the first and the second roller shaft being located proximate a bottom of the tank but at different levels relative to one another in the tank;
a plurality of secondary tanks; and
a film takeup unit;
wherein film is fed by the film feeder into the developer tank and then into the plurality of secondary tanks before it enters the film takeup unit;
wherein a developer solution is maintained in the developer tank at a fluid level which is approximately located at a centerline of the first roller shaft;
wherein the second roller shaft is positioned so that its plurality of rollers are above the centerline; and
wherein film fed into the tank travels over each of the plurality of sprockets and the plurality of rollers of both the first and the second roller shafts before it leaves the tank.

38. A high speed motion picture film processor, comprising:
a film feeder;
a developer tank containing a developer solution and a non-reactive gas comprised of:
a sprocket shaft with a plurality of sprockets;
a roller shaft having a plurality of rollers located proximate a bottom of the tank;
a gas make-up system for adding the non-reactive gas inside of the developer tank; and
a system of seals to minimize leakage of the non-reactive gas and the developer solution from inside of the developer tank outside of the developer tank, comprising:
a first seal along a periphery of the developer tank below the sprocket shaft comprised of a barrier with a lower end in a liquid reservoir formed by an outer wall with an outer wall height, a trough and an inner wall with an inner wall height that is less than the height of the outer wall which is filled with the developer solution when the high speed motion picture film processor is in operation and any overflow flows over the inner wall into the developer tank;
a tank cover;
a second seal along a second periphery of the tank cover above the sprocket shaft comprised of a second barrier with a second barrier lower end in a second liquid reservoir formed by a second outer wall with a second outer wall height, a second trough and a second inner wall with a second inner wall height that is less than the height of the second outer wall which is filled with the developer solution when the high speed motion picture film processor is in operation and any overflow flows over the second inner wall into the developer tank;
a film entrance sealing device; and
a film exit sealing device;
a plurality of secondary tanks; and
a film takeup unit;
wherein film is fed by the film feeder into the film entrance sealing device where it is fed between the plurality of sprockets and the plurality of rollers until it exits the developer tank through the film exit sealing device and is then fed into the plurality of secondary tanks before it enters the film takeup unit.

39. The high speed motion picture film processor of claim 38, further comprising means for preventing the tank cover from being lifted up by the positive pressure inside of the developer tank.

40. The high speed motion picture film processor of claim 38, wherein operation of the high speed motion picture film processor fills the liquid reservoir of both the first and the second seals.

41. The high speed motion picture film processor of claim 38, wherein the first and second liquid reservoirs and the first and second barrier are constructed so as to allow movement of said barrier within said liquid reservoirs without allowing the non-reactive gas to exit the developer tank when the high speed motion picture film processor is in operation.

42. The high speed motion picture film processor of claim 38,
wherein the film exit device is comprised of:
a housing;
a pair of rollers located inside the housing to deflect the path of the film within the housing;
a pair of flexible gas barriers located in the housing in the path of the film between the pair of rollers such that the film passes between a gap between the pair of flexible gas barriers when the film processor is in operation and the pair of flexible gas barriers separate a tank gas chamber located in a first portion of the housing in communication with the developer tank from an air chamber located in a second portion of the housing in communication with ambient air; and
wherein the tank gas chamber contains the non-reactive gas contained in the developer tank at a pressure slightly higher than the pressure in the air chamber; and
wherein the film entrance device is comprised of:
a second housing;
a second pair of rollers located inside the second housing to deflect the path of the film within the second housing;
a second pair of flexible gas barriers located in the second housing in the path of the film between the second pair of rollers such that the film passes between a second gap between the second pair of flexible gas barriers when the film processor is in operation and the second pair of flexible gas barriers separate a second tank gas chamber located in a first portion of the second housing in communication with the developer tank from an air chamber located in a second portion of the second housing in communication with ambient air; and
wherein the second tank gas chamber contains the non-reactive gas contained in the developer tank at a pressure slightly higher than the pressure in the air chamber; and
wherein the second air chamber contains a partial pressure of the non-reactive gas contained in the developer tank.

43. The high speed motion picture film processor of claim 42, wherein the first and second gaps are approximately a few thousands of an inch or less.

44. The high speed motion picture film processor of claim 42, wherein the sprocket shaft is further comprised of:
a first small shaft mounted on a first set of metal bearings inside a first beam with a first flexible seal for preventing gas from leaving the developer tank on a first side of the developer tank;
a second small shaft mounted on a second set of metal bearings inside a second beam with a second flexible seal for preventing gas from leaving the developer tank on a second side of the developer tank opposite the first side of the developer tank; and
a tube affixed at one end to the first small shaft and at its other end to the second small shaft;
means for preventing each of the plurality of sprockets from rotating; and
means for preventing lateral movement of the plurality of sprockets relative to the tube;
wherein the tube has a larger diameter than the first and the second small shafts; and
wherein the plurality of sprockets are mounted on the tube.

45. The high speed motion picture film processor of claim 44, wherein the inside of the first and the second beams are slightly pressurized relative to the positive pressure of the developer tank.

46. The high speed motion picture film processor of claim 44, further comprising:
a primary oxygen sensor located outside of the developer tank for sounding an alarm whenever oxygen concentration exceeds a desired set point;
a filter;
a gas line for feeding the non-reactive gas inside of the developer tank to the filter and then to the primary oxygen sensor;
a primary oxygen sensor exhaust for exhausting the non-reactive gas from the primary oxygen sensor; and
a primary oxygen sensor exhaust throttling device placed at the primary oxygen sensor exhaust;
wherein the non-reactive gas is fed to the primary oxygen sensor due to the positive pressure of the non-reactive gas within the developer tank.

47. The high speed motion picture film processor of claim 46, further comprising:
a secondary oxygen sensor located outside of the developer tank for sounding an alarm whenever oxygen concentration exceeds the desired set point;
a switching device for periodically switching flow of gas from the filter to the secondary oxygen sensor instead of the primary oxygen sensor and then to switch the flow of gas back again to the primary oxygen sensor;
a secondary oxygen sensor exhaust for exhausting the non-reactive gas from the secondary oxygen sensor; and
a secondary oxygen sensor exhaust throttling device placed at the secondary oxygen sensor exhaust.

48. The high speed motion picture film processor of claim 46, further comprising an overpressure relief valve.

49. A sealed tank for use in a high speed motion picture film processor, comprising:
a sprocket shaft with at least one sprocket;
a roller shaft having at least one roller at least partially submerged in a tank solution located proximate a bottom of the tank;
a pressure control system for maintaining a desired pressure of a tank gas within the tank relevant to an ambient air pressure outside of the tank; and
a system of seals to minimize leakage of the tank gas and the tank solution from inside of the tank outside of the tank, comprising:
a first seal along a periphery of the tank below the sprocket shaft comprised of a barrier with a lower end in a liquid reservoir formed by an outer wall with an outer wall height, a trough and an inner wall with an inner wall height that is less than the height of the outer wall which is filled with the tank solution when the high speed motion picture film processor is in operation and any overflow flows over the inner wall into the tank;
a tank cover;
a second seal along a second periphery of the tank cover above the sprocket shaft comprised of a second barrier with a second barrier lower end in a second liquid reservoir formed by a second outer wall with a second outer wall height, a second trough and a second inner wall with a second inner wall height that is less than the height of the second outer wall which is filled with the tank solution when the high speed motion picture film processor is in operation and any overflow flows over the second inner wall into the tank;
a film entrance sealing device; and
a film exit sealing device;
wherein film is fed into the film entrance sealing device where it is fed between the at least one sprocket and the at least one roller until it exits the tank through the film exit sealing device after coming into contact with the tank solution.

50. The high speed motion picture film processor of claim 49, wherein the sprocket shaft is further comprised of:
a first small shaft mounted on a first set of bearings inside a first beam with a first flexible seal for preventing gas from leaving the tank on a first side of the tank;
a second small shaft mounted on a second set of bearings inside a second beam with a second flexible seal for preventing gas from leaving the tank on a second side of the tank opposite the first side of the tank; and
a tube affixed at one end to the first small shaft and at its other end to the second small shaft;
wherein the tube has a larger diameter than the first and the second small shafts and the tube is substantially stiffer than either the first or the second small shafts; and
wherein the at least one sprocket is mounted on the tube.

51. The high speed motion picture film processor of claim 50, wherein the tube is a solid rod.
